(19) United States
(12) Patent Application Publication
(10) Pub. No.: US 2026/0152120 A1
(43) Pub. Date: Jun. 4, 2026

(54) ILLUMINATION DEVICE

(71) Applicant: TOYODA GOSEI CO., LTD., Kiyosu-shi (JP)

(72) Inventors: Kazuma MURAMATSU, Aichi (JP); Akitoshi NAGANAWA, Aichi (JP)

(21) Appl. No.: 19/400,695

(22) Filed: Nov. 25, 2025

(30) Foreign Application Priority Data
Nov. 29, 2024 (JP) 2024-208109

(51) Int. Cl. B60Q 3/283; B60K 35/21; B60Q 3/64

(52) U.S. Cl. CPC B60Q 3/283; B60K 35/21; B60Q 3/64; B60K 2360/332; B60K 2360/338; B60K 2360/685; B60K 2360/782

(57) ABSTRACT

An illumination device to be provided in a steering wheel, includes: a substrate provided with a light emitting element on a surface of the substrate; a lens member that is light-transmissive so that visible light output from the light emitting element is emitted to an outside of the steering wheel; a light guiding member configured to guide the visible light output from the light emitting element to the lens member; and a separate member different from the substrate, the lens member and the light guiding member, and the substrate is held by being sandwiched between the light guiding member and the lens member or the separate member.

### CROSS-REFERENCE TO RELATED APPLICATION

This application is based on and claims priority under 35 USC 119 from Japanese Patent Application No. 2024-208109 filed on November 29, 2024.

### TECHNICAL FIELD

The present disclosure relates to an illumination device to be provided in a steering wheel.

### BACKGROUND ART

It has been proposed to attach a device (hereinafter, referred to as an "illumination device") that emits light such as visible light and infrared light to a steering wheel at a position viewable to a driver and use the device. For example, Patent Literature 1 discloses an illumination device including a substrate provided with a light source, a diffuser extending along a rim and constituting an outer wall from which light is emitted, and a light guiding member guiding light emitted from the light source to the diffuser. In the illumination device, a relative positional relation between the light guiding member and the diffuser is fixed by engaging the light guiding member with the diffuser.

### Patent Literature 1: WO2022/157129A1

### SUMMARY OF INVENTION

However, in the illumination device according to Patent Literature 1, since a relative positional relation between the light source and the light guiding member is not fixed, the positional relation may be deviated. For example, when FIG. 2 and FIG. 3 according to Patent Literature 1 are compared with each other, in the configuration of FIG. 3, the light guiding member is shifted upward with respect to the light source compared to the configuration of FIG. 2. When the relative positional relation between the light source and the light guiding member is deviated as described above, a problem that a luminance at a light emitting surface of the illumination device is deviated from a predetermined luminance or a problem that luminance unevenness occurs at the light emitting surface may occur. An object of the present disclosure is to provide an illumination device to be provided in a steering wheel, which is capable of restraining a deviation in a relative positional relation between a light source and a light guiding member.

The present disclosure has been made to solve at least a part of the above problems, and can be implemented in the following aspects.

An aspect of the present disclosure provides an illumination device to be provided in a steering wheel. The illumination device includes a substrate provided with a light emitting element on a surface of the substrate; a lens member that is light-transmissive so that visible light output from the light emitting element is emitted to an outside of the steering wheel; a light guiding member configured to guide the visible light output from the light emitting element to the lens member; and a separate member different from the substrate, the lens member, and the light guiding member, in which the substrate is held by being sandwiched between the light guiding member and the lens member or the separate member.

According to the illumination device of the aspect, since the substrate is held by being sandwiched between the light guiding member and the lens member or the separate member, it is possible to restrain a deviation in a relative positional relation between the light guiding member and the light emitting element serving as a light source provided on the surface of the substrate. In addition, since no dedicated member is required to fix the light guiding member and the substrate to each other, it is possible to achieve a reduction in manufacturing cost and a reduction in size and weight of the illumination device.

In the illumination device of the aspect, the separate member may include a base member to which the substrate and the lens member are attached and which holds the substrate and the lens member, and the substrate may be held by being sandwiched between the light guiding member and the base member.

According to the illumination device of the aspect, since the substrate is held by being sandwiched between the light guiding member and the base member, it is possible to manufacture an assembly in which the substrate, the light guiding member, and the base member are integrated.

In the illumination device of the aspect, the light guiding member may include a first light guiding portion having an emission surface through which the visible light is emitted from the light guiding member to the lens member, the first light guiding portion extending along a first direction from the surface of the substrate toward the lens member, the base member may include a first surrounding portion surrounding at least a part of a side surface of the first light guiding portion over an entire periphery of the first light guiding portion, and the first surrounding portion and the substrate may be in contact with the first light guiding portion.

According to the illumination device of the aspect, since the first surrounding portion and the substrate are in contact with the first light guiding portion, positioning of the first surrounding portion, the substrate, and the first light guiding portion can be easily achieved at the time of assembly. In addition, it is possible to restrain occurrence of a relative positional misalignment between the first surrounding portion, the substrate, and the first light guiding portion at the time of use.

In the illumination device of the aspect, the lens member may include a second surrounding portion surrounding at least a part of a side surface of the first light guiding portion over an entire periphery of the first light guiding portion, and the first surrounding portion may include a positioning portion for positioning at least one of the first light guiding portion and the second surrounding portion.

According to the illumination device of the aspect, since the first surrounding portion includes the positioning portion for positioning at least one of the first light guiding portion and the second surrounding portion, positioning of the first surrounding portion and at least one of the first light guiding portion and the second surrounding portion can be easily achieved.

In the illumination device of the aspect, the separate member may include a core member forming a framework of the steering wheel, and the substrate may be held by being sandwiched between the light guiding member and the core member.

According to the illumination device of the aspect, since the substrate is held by being sandwiched between the light guiding member and the core member resistant to an impact, it is possible to restrain occurrence of a positional misalignment of the substrate even when an impact is applied from the outside. Further, heat in the substrate can be easily dissipated to the core member.

In the illumination device of the aspect, the substrate may be held by being sandwiched between the light guiding member and the lens member.

According to the illumination device of the aspect, since the substrate is held by being sandwiched between the light guiding member and the lens member, it is possible to easily align the center of the light guiding member with the center of the lens member and to easily maintain an aligned state thereof. Further, an assembly in which the substrate, the lens member, and the light guiding member are integrated can be used as a separate member from other members constituting the steering wheel. Therefore, for example, when a leather member is wound to form an outer skin layer as the outermost layer of the steering wheel, the leather member can be wound in a state in which the assembly is removed, and working efficiency can be improved.

In the illumination device of the aspect, the light guiding member may include a first light guiding portion having an emission surface through which the visible light is emitted from the light guiding member to the lens member, the first light guiding portion extending along a first direction from the surface of the substrate toward the lens member, the lens member may include a second surrounding portion surrounding at least a part of a side surface of the first light guiding portion over an entire periphery of the first light guiding portion, and the substrate may be held by being sandwiched between the light guiding member and an end portion of the second surrounding portion.

According to the illumination device of the aspect, since the lens member includes the surrounding portion surrounding at least a part of the side surface of the first light guiding portion over the entire periphery of the first light guiding portion, positioning of the first light guiding portion at the time of assembly can be facilitated, and a positional misalignment of the first light guiding portion at the time of use can be restrained.

### BRIEF DESCRIPTION OF DRAWINGS

FIG. 1 is a plan view showing an external shape of a steering wheel in a state in which an illumination device as an embodiment of the present disclosure is attached;

FIG. 2 is a plan view showing an external shape of the steering wheel in a state in which a lens member and a base member are removed;

FIG. 3 is a first exploded perspective view showing a detailed configuration of the illumination device;

FIG. 4 is a second exploded perspective view showing the detailed configuration of the illumination device;

FIG. 5 is a sectional view showing a cross section of the steering wheel;

FIG. 6 is a partially enlarged sectional view of a steering wheel according to a second embodiment;

FIG. 7 is a sectional view showing a cross section of a steering wheel according to a third embodiment; and

FIG. 8 is a sectional view showing a cross section of a steering wheel according to a fourth embodiment.

### DESCRIPTION OF EMBODIMENTS

### A. First Embodiment

### A1. Overall Configuration of Steering Wheel 100

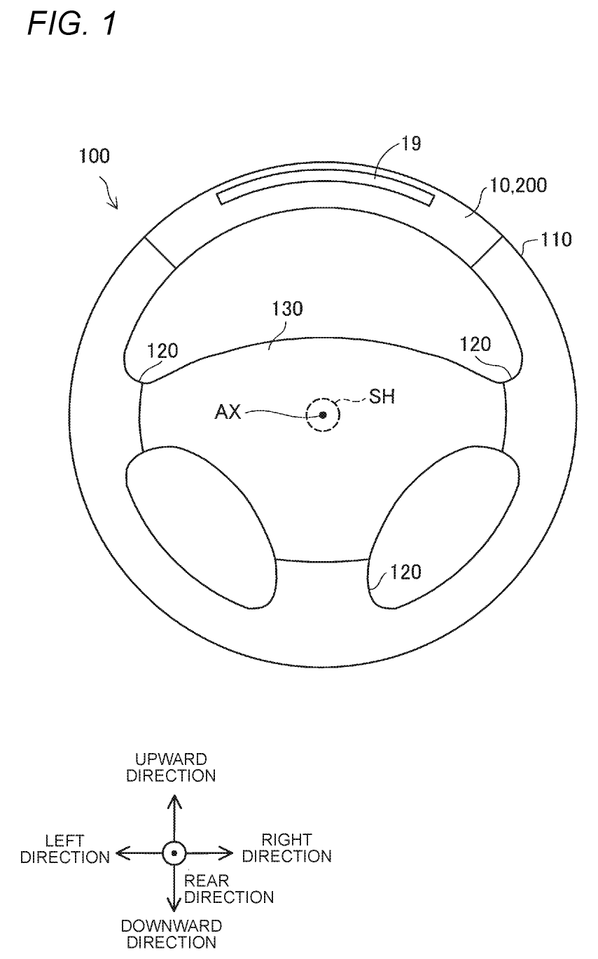

FIG. 1 is a plan view showing an external shape of a steering wheel 100 in a state in which an illumination device 200 as an embodiment of the present disclosure is attached. The steering wheel 100 is disposed in a driver's seat area of a vehicle and is used by a driver. Examples of the vehicle include a vehicle equipped with an engine, a hybrid vehicle (HEV), a plug-in hybrid vehicle (PHEV), a battery electric vehicle (BEV), and a fuel cell vehicle (FCV). The steering wheel 100 is a part of a steering device operated by the driver of the vehicle. FIG. 1 shows the steering wheel 100 in a state of being coupled to a steering shaft SH in the vehicle and causing the vehicle to travel straight (hereinafter, also referred to as a "reference state"). FIG. 1 shows an external configuration of the steering wheel 100 on a side facing the driver (a "rear" side to be described later). The steering wheel 100 is configured to enable a rotation operation about an axis AX of the steering shaft SH. The rotation of the steering wheel 100 is transmitted to a steering gear box (not shown) via the steering shaft SH.

In the present embodiment, a direction along the axis AX of the steering shaft SH is referred to as a "front-rear direction" (a front direction and a rear direction) in association with a traveling direction of the vehicle. Among directions orthogonal to the axis AX, a direction overlapping with a vertical direction (a vertically upward direction and a vertically downward direction) when viewed by the driver is referred to as an "upward-downward direction". Among the directions orthogonal to the axis AX, a direction parallel to left and right directions (a width direction) of the vehicle is referred to as a "left-right direction".

The steering wheel 100 includes a ring-shaped grip portion 110, a boss portion 130 disposed at a substantially central portion of the grip portion 110, three spoke portions 120, and the illumination device 200 disposed at a part of the grip portion 110.

The grip portion 110 is gripped by the driver when the steering wheel 100 is operated. In the present embodiment, the grip portion 110 has a substantially circular ring shape. A center axis of the grip portion 110 coincides with the axis AX of the steering shaft SH. The shape of the grip portion 110 may be any shape such as a polygonal shape and an elliptical shape instead of the substantially circular ring shape, and may be a non-symmetrical shape such as a so-called D shape. Further, the shape of the grip portion 110 is not limited to an annular shape, and may be any shape formed by a plurality of parts provided at positions separated from each other. As described below, the grip portion 110 is configured by stacking a plurality of members in a thickness direction. The outermost layer is formed by an outer skin layer (an outer skin layer 80 to be described later) formed of a leather member. Although not shown in FIG. 1, in the grip portion 110, a recess (a recess C1 to be described later) that accommodates a part of the illumination device 200 is formed in a part of the grip portion 110 on the upper side in the reference state. The part of the illumination device 200 is accommodated in the recess C1. In other words, the illumination device 200 is fitted into the recess C1. Further, an opening of the recess C1 is closed by the illumination device 200.

The three spoke portions 120 couple the grip portion 110 and the boss portion 130. The boss portion 130 corresponds to a connection portion when the steering wheel 100 is connected to the steering shaft SH. A folded air bag and an inflator, which are not shown, are accommodated in the boss portion 130. Further, a temperature control circuit constituting a heater, and various sensor devices for detecting room temperature and gripping of the grip portion 110 by a user may be accommodated in the boss portion 130. The three spoke portions 120 and the boss portion 130 may be provided with various operation buttons for operating a navigation device, an audio device, and the like mounted on the vehicle.

The illumination device 200 emit light. In the present embodiment, the light emitted by the illumination device 200 includes visible light and infrared light (infrared ray). By emitting the visible light from the illumination device 200, the driver can be notified of various information. For example, by emitting lights of various colors or blinking light, the driver can be notified of some information. Specifically, it is possible to prompt the driver to grip the steering wheel by emitting red light. In addition, by emitting the infrared light from the illumination device 200, a part of the body of the driver can be clearly photographed by an infrared camera in a dark interior cabin at night.

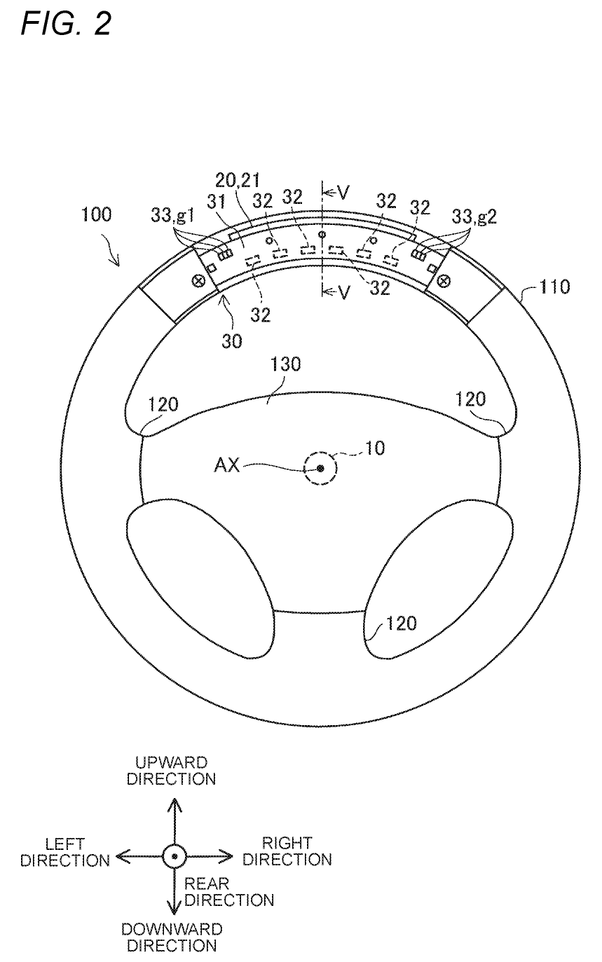

FIG. 2 is a plan view showing an external shape of the steering wheel 100 in a state in which a lens member 10 and a base member 40 are removed. As described below, in the illumination device 200, the lens member 10, that is light-transmissive, is disposed at a position facing the driver, and the light guiding member 20, a light emitting portion 30, and the base member 40, which will be described later, are disposed on the front direction side of the lens member 10. FIG. 2 schematically shows the steering wheel 100 in the state in which the lens member 10 and the base member 40 are removed.

As shown in FIG. 2, when the lens member 10 and the base member 40 are removed, the light emitting portion 30, which is one of components constituting the illumination device 200, and a part (a second light guiding portion 22 to be described later) of the light guiding member 20 are exposed. The light emitting portion 30 includes a substrate 31 and a plurality of light emitting elements provided on both surfaces of the substrate 31. In the present embodiment, the "plurality of light emitting elements" include a plurality of first LEDs 32 provided on a back surface (surface on the front direction side) of the substrate 31 and a plurality of second LEDs 33 provided on a front surface (surface on the rear direction side) of the substrate 31. The substrate 31 has an arc-like and belt-like external shape that is curved along a circumferential direction of the grip portion 110 (hereinafter, also simply referred to as the "circumferential direction") when viewed by the driver. Hereinafter, a radial direction (a direction orthogonal to the axis AX) of the grip portion 110 is also simply referred to as the "radial direction". The plurality of first LEDs 32 are disposed at positions close to an end portion on the downward direction side of the surface (back surface) of the substrate 31 so as to be separated from each other by a predetermined distance along the circumferential direction. The first LEDs 32 emit the visible light. In the present embodiment, a visible light LED capable of emitting red light, green light, and blue light is used as the first LED 32. The plurality of second LEDs 33 form two groups g1 and g2 disposed to be separated from each other. Each of the groups g1 and g2 includes a plurality of second LEDs 33 adjacent to each other in the circumferential direction. Each of the two groups g1 and g2 is disposed at a position close to an end portion on the upward direction side of the surface (front surface) of the substrate 31. The two groups g1 and g2 are disposed to be separated from each other so as to sandwich the plurality of first LEDs 32 when viewed along the circumferential direction.

### A2. Detailed Configuration of Illumination Device 200

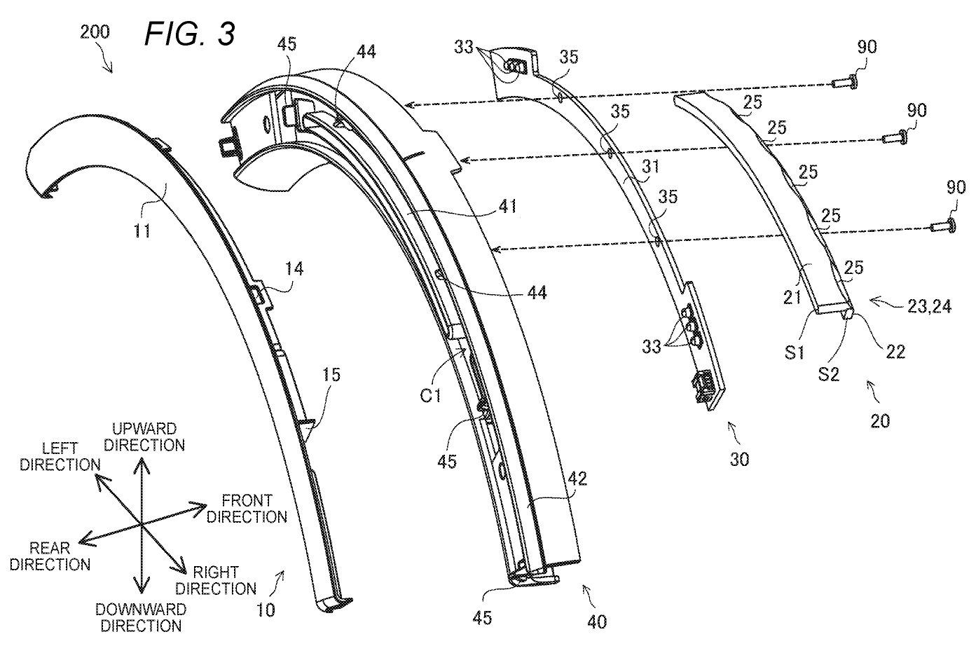

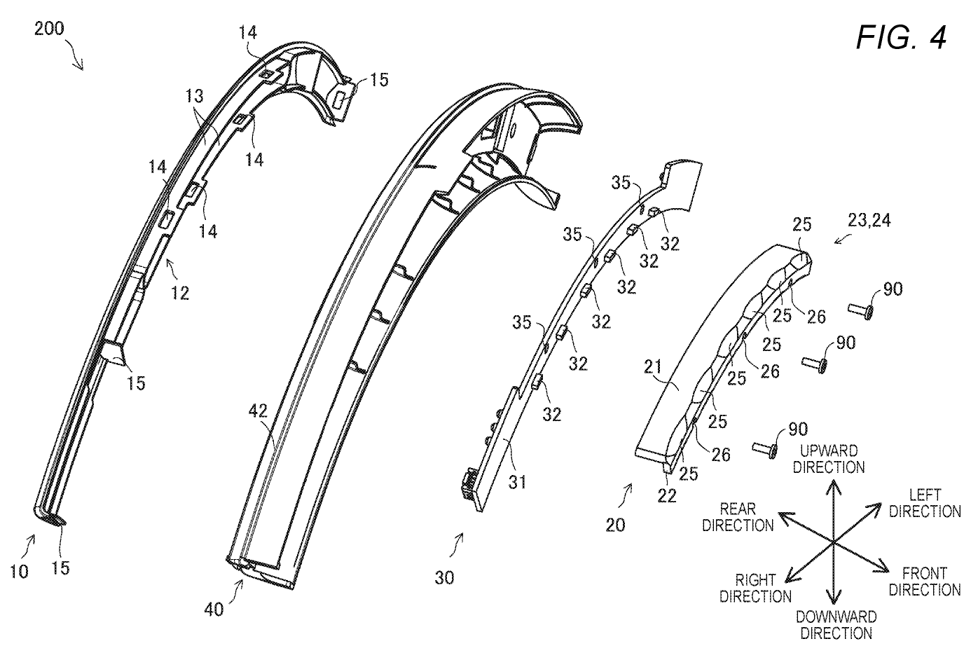

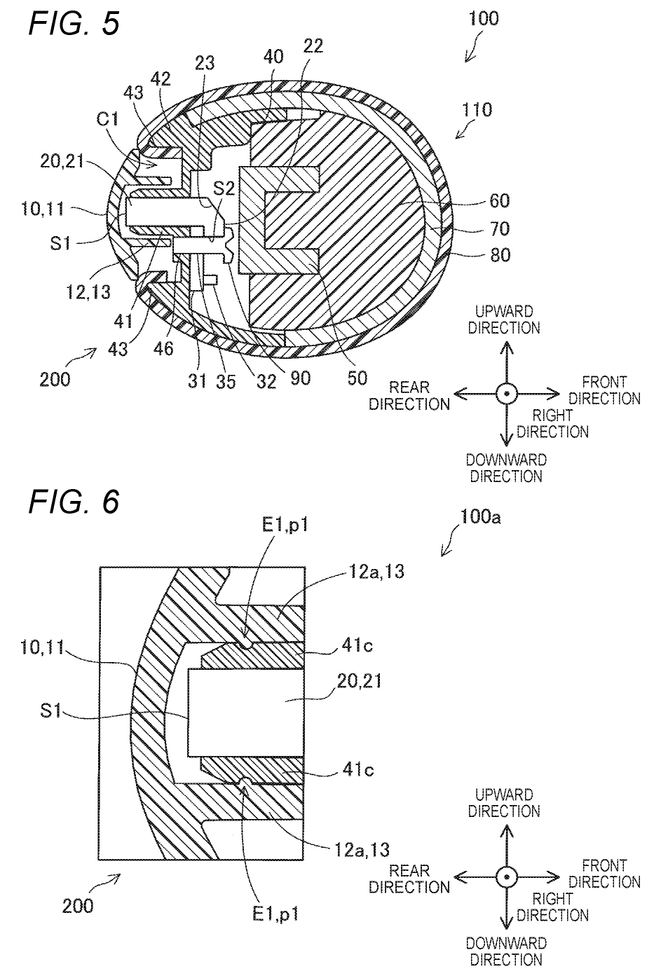

FIG. 3 is a first exploded perspective view showing a detailed configuration of the illumination device 200. FIG. 4 is a second exploded perspective view showing the detailed configuration of the illumination device 200. FIG. 5 is a sectional view showing a cross section of the steering wheel 100. FIG. 3 corresponds to an exploded perspective view of the illumination device 200 viewed substantially from the rear side toward the front side. FIG. 4 corresponds to an exploded perspective view of the illumination device 200 viewed substantially from the front side toward the rear side. FIG. 5 shows a cross section taken along a line V-V shown in FIG. 2.

As shown in FIGS. 3 and 4, the illumination device 200 includes the lens member 10, the light guiding member 20, and the base member 40 in addition to the light emitting portion 30 described above. The illumination device 200 has a structure in which the light guiding member 20 and the light emitting portion 30, and the lens member 10 are integrally assembled in the front-rear direction with the base member 40 sandwiched therebetween.

As shown in FIGS. 3 and 4, the lens member 10 includes a diffusion surface forming portion 11, a second surrounding portion 12, and a plurality of engaging walls 15. The diffusion surface forming portion 11 forms an outer surface of the steering wheel 100 continuously with the outer skin layer 80 as shown in FIG. 5. As shown in FIGS. 3 and 4, similarly to the substrate 31 described above, the diffusion surface forming portion 11 has an arc-like and belt-like external shape that is curved along the circumferential direction of the grip portion 110 when viewed by the driver. The diffusion surface forming portion 11 is transparent to the visible light and the infrared light, and forms a diffusion surface for diffusing the light received from the light emitting portion 30 via the light guiding member 20 into the interior cabin. In the present embodiment, the diffusion surface forming portion 11 has a transmittance of about 25% with respect to the visible light and a transmittance of about 90% with respect to the infrared light. Each of the transmittances with respect to the visible light and the infrared light may be any value higher than 0%. In the present embodiment, the diffusion surface forming portion 11 is made of a black transparent synthetic resin in accordance with the black outer skin layer 80. The diffusion surface forming portion 11 may be covered with the outer skin layer 80. In such a configuration, the outer skin layer 80 is light-transmissive, and thus the diffusion surface can diffuse the light received from the light emitting portion 30 into the interior cabin.

The diffusion surface forming portion 11 has, in addition to a function of diffusing the light received from the light emitting portion 30 and a function of protecting the light emitting portion 30, a function of limiting a region through which the visible light emitted from the first LEDs 32 is transmitted (in other words, a function of masking a region which is not desired to be illuminated), and a function of deflecting an emission direction of the infrared light emitted from the second LEDs 33 to be directed to the upper side on the rear direction side which is a driver side. A light emitting region 19 shown in FIG. 1 is a region through which the visible light is transmitted. On the other hand, in FIG. 1, a region of the diffusion surface forming portion 11 other than the light emitting region 19 is a region in which transmission of the visible light is limited.

As shown in FIG. 4, the second surrounding portion 12 is provided on a surface (an inner surface) of the diffusion surface forming portion 11 on the front direction side. In a state in which the illumination device 200 is assembled (hereinafter, also simply referred to as an "assembled state"), the second surrounding portion 12 is disposed to surround a first surrounding portion 41 protruding from the recess C1 of the base member 40 shown in FIGS. 3 and 5 toward the rear direction side, and a first light guiding portion 21 (to be described later) corresponding to a part of the light guiding member 20 accommodated in the first surrounding portion 41 over the entire periphery. The recess C1 has a groove-shaped structure that opens into a surface of the base member 40 in the front direction and extends along the circumferential direction. In the second surrounding portion 12, a protrusion 13 corresponding to a side wall along the radial direction protrudes from the surface of the diffusion surface forming portion 11 on the front direction side, that is, the inner surface to a depth direction of the recess C1. In the present embodiment, the "depth direction of the recess C1" substantially coincides with the front-rear direction as evident from FIGS. 3 and 5. As shown in FIG. 4, a plurality of engaging holes 14 are formed in the protrusion 13. In the assembled state, engaging claws 44 (see FIG. 3) provided in an outer peripheral surface of the first surrounding portion 41 of the base member 40 are engaged with the engaging holes 14. Such engagement is achieved as a so-called snap-fit. As shown in FIG. 4, each of the plurality of engaging walls 15 has a thin wall-like external shape protruding in the front direction, and is provided with an engaging hole. In the assembled state, the engaging walls 15 are disposed in contact with engaging walls 45 (see FIG. 3) of the base member 40. Further, in the assembled state, engaging claws provided in the engaging walls 45 are engaged with the engaging holes of the engaging walls 15. Such engagement is also achieved as the so-called snap-fit.

The light guiding member 20 guides the light (the visible light) emitted from the first LEDs 32 to the lens member 10. In the present embodiment, the light guiding member 20 is made of a polycarbonate (PC) resin. The light guiding member 20 may be made of an acrylic resin instead of the PC resin. As shown in FIGS. 3 to 5, the light guiding member 20 has an external shape whose cross-sectional shape along the axis AX is a substantially L shape. In addition, the light guiding member 20 has an arc-like external shape in accordance with disposed positions of the plurality of first LEDs 32 when viewed by the driver.

As shown in FIGS. 3 to 5, the light guiding member 20 includes the first light guiding portion 21, the second light guiding portion 22, and a deflection portion 23. The first light guiding portion 21 includes an emission surface S1 through which the visible light is emitted from the light guiding member 20 to the lens member 10. The first light guiding portion 21 extends along a direction (hereinafter, also referred to as a "first direction") from the surface (front surface) of the substrate 31 toward the lens member 10. The first direction is parallel to the front direction. The second light guiding portion 22 has an incident surface S2 on which the visible light output from the first LEDs 32 is incident. As shown in FIG. 5, the incident surface S2 is located above the first LEDs 32. Therefore, the visible light is incident on the incident surface S2 upward from the first LEDs 32. The second light guiding portion 22 extends along a direction (hereinafter, also referred to as a "second direction") intersecting the first direction. The second direction corresponds to an upward direction and a substantially upward direction in the state of FIG. 5. In the present embodiment, the first direction and the second direction are orthogonal to each other. The deflection portion 23 connects the first light guiding portion 21 and the second light guiding portion 22, reflects the visible light derived from the second light guiding portion 22, and inputs the visible light to the first light guiding portion 21. More specifically, the deflection portion 23 deflects the visible light, which is incident on the second light guiding portion 22 from the incident surface S2 and travels upward, forward and inputs the deflected visible light to the first light guiding portion 21. As shown in FIG. 4, the deflection portion 23 has a deflection surface 24 that deflects the visible light. A plurality of diffusion portions 25 are formed on the deflection surface 24. The diffusion portions 25 are disposed at positions corresponding to the first LEDs 32 in the upward direction. Each diffusion portion 25 has a recessed structure obtained by partially chamfering the deflection surface 24. Specifically, each diffusion portion 25 has a recessed structure in which a position corresponding to the first LED 32 in the upward direction is most recessed and the depth gradually decreases toward positions corresponding to the adjacent first LEDs 32 along the circumferential direction. In addition, the width, that is, the dimension in the upward-downward direction of each diffusion portion 25 is largest at a position corresponding to the first LED 32 in the upward direction (more accurately, a direction toward the outside in the radial direction), and gradually decreases toward positions corresponding to the adjacent first LEDs 32 along the circumferential direction. By the deflection portion 23 having such a structure, the visible light of a so-called point light source output from the first LEDs 32 is diffused in the circumferential direction and the upward-downward direction when the visible light is deflected at the deflection portion 23. As shown in FIG. 5, in the assembled state, the first light guiding portion 21 is accommodated in the recess C1 over an edge of the substrate 31 in the upward direction. On the other hand, in the assembled state, the second light guiding portion 22 and the deflection portion 23 are located on the front direction side of the base member 40, and are not accommodated in the recess C1.

The base member 40 holds the second light guiding portion 22 of the light guiding member 20 and the light emitting portion 30 attached to the front direction side thereof, and holds the first light guiding portion 21 of the light guiding member 20 and the lens member 10 attached to the rear direction side thereof. Details of the assembled state of the base member 40, the light guiding member 20, and the light emitting portion 30 (the substrate 31) will be described later. As shown in FIGS. 3 and 4, the base member 40 has an arc-like and belt-like external shape that is curved along the circumferential direction when viewed by the driver. In the present embodiment, the base member 40 is configured as a single component made of an ABS resin. The base member 40 may be configured as a single component made of a PC resin instead of the ABS resin or in addition to the ABS resin. Alternatively, the base member 40 may be configured as a composite component obtained by combining a plurality of components. As described above, the recess C1 continuous in the circumferential direction is formed in a surface of the base member 40 on the rear direction side. As shown in FIGS. 3 to 5, on the surface of the base member 40 on the rear direction side, a covering portion 42 continuous in the circumferential direction is provided on the upward direction side and the downward direction side with the recess C1 sandwiched therebetween. As shown in FIGS. 5 and 6, a cross-sectional shape of an outer surface of the covering portion 42 is a shape in which an angle formed by a surface existing in the upward direction and a surface existing in the downward direction with a top portion 43 sandwiched therebetween is an acute angle. The covering portion 42 is covered with the outer skin layer 80 to be described later.

In the recess C1, a through hole penetrating in the thickness direction is formed in a portion corresponding to the light guiding member 20. As shown in FIG. 5, the first light guiding portion 21 of the light guiding member 20 is inserted into the through hole. As shown in FIGS. 3 and 5, in the recess C1, the above first surrounding portion 41 is provided to surround the through hole into which the first light guiding portion 21 is inserted. Similarly to the second surrounding portion 12 of the lens member 10 shown in FIG. 4, the first surrounding portion 41 is formed to protrude in the rear direction so as to surround the through hole and a side surface of the first light guiding portion 21 inserted into the through hole in a contact state over the entire periphery. As shown in FIG. 3, the first surrounding portion 41 has a flat cylindrical external shape curved to an arc shape. As described above, the plurality of engaging claws 44 are provided in the outer peripheral surface of the first surrounding portion 41, and the engaging claws 44 are engaged with the engaging holes 14 of the lens member 10 in the assembled state. The first surrounding portion 41 restrains a positional misalignment of the light guiding member 20 including the first light guiding portion 21 in the upward-downward direction and the left-right direction.

### A3. Detailed Configuration of Grip Portion 110

In the grip portion 110, a cross-sectional configuration of a portion other than the portion to which the illumination device 200 is attached is different from the cross-sectional configurations of the portion to which the illumination device 200 is attached shown in FIG. 5 in that the illumination device 200 is not attached, and is the same in other points.

As shown in FIG. 5, the grip portion 110 includes a core member 50, a core portion 60, an element layer 70, the above illumination device 200, and the outer skin layer 80.

The core member 50 is made of metal and is a member serving as a framework of the grip portion 110. In the present embodiment, the core member 50 is made of an aluminum alloy. The core member 50 may be made of any kind of metal such as a magnesium alloy and steel instead of the aluminum alloy. The core portion 60 is disposed to cover the entire core member 50, and forms a core of the grip portion 110. The core portion 60 is made of a soft synthetic resin having a cushioning property. Specifically, in the present embodiment, the core portion 60 is made of a soft foamed material such as foamed polyurethane. The element layer 70 partially covers the core portion 60. The element layer 70 is a layer provided with an electric heating wire constituting the heater and an electrode for detecting the gripping. For example, the element layer 70 is made of a conductive cloth obtained by performing a surface treatment such as carbon coating and metal plating to a fiber cloth. As shown in FIG. 5, the element layer 70 also covers a part of the base member 40 at the portion of the grip portion 110 to which the illumination device 200 is attached. An outer surface of the element layer 70 and a part of an outer surface of the base member 40 form a continuous curved surface. The outer skin layer 80 continuously covers the outer surface of the element layer 70, the outer surface of the covering portion 42 of the base member 40, and the inside of the recess C1 of the base member 40. As shown in FIG. 5, terminal portions of the leather member constituting the outer skin layer 80 are accommodated in the recess C1. The outer skin layer 80 is formed of the leather member. In the present embodiment, the leather member is made of natural leather such as a top leather and a split leather divided from the top leather. The leather member may be made of any kind of leather material such as synthetic leather and artificial leather instead of the natural leather.

### A4. Manufacturing Method of Steering Wheel 100

A manufacturing method (an assembling method) of the steering wheel 100 having the above configuration will be described. First, a member obtained by removing the lens member 10 from the illumination device 200 (hereinafter, referred to as an "illumination subassembly") is manufactured. Specifically, first, the lens member 10, the light guiding member 20, the light emitting portion 30, and the base member 40 are manufactured, respectively. Then, the light guiding member 20 and the light emitting portion 30 are attached to a back surface (the surface on the front direction side in the assembled state) of the base member 40. At this time, three screws 90 shown in FIGS. 3 and 4 are screwed into screw holes 46 (see FIG. 5) provided in the base member 40 while being accommodated in through holes 35 provided in the substrate 31. In this way, the illumination subassembly is completed. Next, the core member 50 is formed. The core portion 60 and the element layer 70 are formed to surround the core member 50. Hereinafter, the member obtained in this manner is referred to as a "wheel element". The formation of the wheel element may be achieved by, for example, two-color molding. Subsequently, the illumination subassembly is fastened to the core member 50 by using screws. Accordingly, the wheel element and the illumination subassembly are integrated. In FIG. 5, the cross section of a portion without fastening screws is shown. Since the illumination subassembly and the core member 50 are fastened to each other by the screws in this manner, heat generated with the light emission of the light emitting portion 30 can be transmitted to the core member 50, and an excessive increase in the temperature of the illumination device 200 can be restrained. Subsequently, the leather member is wound around an outer surface of the member obtained by integrating the wheel element and the illumination subassembly to form the outer skin layer 80. The outer skin layer 80 may be formed by, for example, winding a plurality of parts of the leather member in the circumferential direction. Subsequently, an adhesive is applied to a wall surface of the recess C1, the terminal portions of the outer skin layer 80 are bent along the shape of the covering portion 42 and are accommodated in the recess C1, and the terminal portions are adhered to the wall surface of the recess C1. Subsequently, the lens member 10 is fitted into the recess C1, and the lens member 10 is attached to the base member 40 by the snap-fit. In addition to the above procedure, there are procedures such as a procedure of accommodating the air bag and the inflator (not shown) in the boss portion 130, and descriptions of these procedures are omitted.

### A5. Details of Assembled State of Base member 40, Light guiding member 20, and Light emitting portion 30 (Substrate 31)

As shown in FIG. 5, the substrate 31 is held by being sandwiched between the light guiding member 20 and the base member 40. Specifically, the second light guiding portion 22 is in contact with a portion of the substrate 31 in the vicinity of an outer edge in the upward direction from the front direction, and a wall surface constituting the bottom of the recess C1 in the base member 40 is in contact with the entire surface of the substrate 31 in the rear direction from the rear direction. Then, the screws 90 are screwed into the screw holes 46 of the base member 40 through the through holes 35 of the substrate 31 while pressing the second light guiding portion 22, so that the substrate 31 is held by being sandwiched between the light guiding member 20 and the base member 40. As described above, since the substrate 31 is held by being sandwiched between the light guiding member 20 and the base member 40, it is possible to restrain a deviation in a relative positional relation between the light guiding member 20 and the first LEDs 32 serving as light sources provided on the surface of the substrate 31. The substrate 31 is attached to the base member 40 by screwing the screws 90 into the screw holes 46 of the base member 40 with the substrate 31 and the light guiding member 20 (the second light guiding portion 22) sandwiched therebetween, that is, by screwing. Then, the substrate 31 is held by the light guiding member 20 and the base member 40 due to the screwing. Therefore, the holding of the substrate 31 by the light guiding member 20 and the base member 40 can be more reliably achieved, and such a holding state can be maintained for a longer time.

As shown in FIG. 5, in the assembled state, the first surrounding portion 41 and the substrate 31 are in contact with the first light guiding portion 21. Specifically, an inner peripheral surface of the first surrounding portion 41 and an end surface of the substrate 31 in the upward direction are in contact with an outer peripheral surface of the first light guiding portion 21 in the downward direction. With such a configuration, positioning of the first surrounding portion 41, the substrate 31, and the first light guiding portion 21 can be easily achieved at the time of assembly. In addition, a relative positional misalignment between the first surrounding portion 41, the substrate 31, and the first light guiding portion 21 can be restrained at the time of use.

According to the illumination device 200 of the first embodiment described above, since the substrate 31 is held by being sandwiched between the light guiding member 20 and the base member 40, it is possible to restrain the deviation in the relative positional relation between the light guiding member 20 and the first LEDs 32 serving as the light sources provided on the surface of the substrate 31.

In addition, since no dedicated member is required to fix the light guiding member 20 and the substrate 31 to each other, it is possible to achieve a reduction in manufacturing cost and a reduction in size and weight of the illumination device 200.

Since the substrate 31 is held by being sandwiched between the light guiding member 20 and the base member 40, it is possible to manufacture an assembly in which the substrate 31, the light guiding member 20, and the base member 40 are integrated.

Since the first surrounding portion 41 and the substrate 31 are in contact with the first light guiding portion 21, the positioning of the first surrounding portion 41, the substrate 31, and the first light guiding portion 21 can be easily achieved at the time of assembly. In addition, it is possible to restrain the occurrence of the relative positional misalignment between the first surrounding portion 41, the substrate 31, and the first light guiding portion 21 at the time of use.

### B. Second Embodiment

FIG. 6 is a partially enlarged sectional view of a steering wheel 100a according to a second embodiment. FIG. 6 shows an enlarged view in the vicinity of the emission surface S1 of the first light guiding portion 21. The steering wheel 100a according to the second embodiment is different from the steering wheel 100 according to the first embodiment in that the base member 40 includes a first surrounding portion 41a instead of the first surrounding portion 41 and that a second surrounding portion 12a is provided instead of the second surrounding portion 12. Other components of the steering wheel 100a according to the second embodiment are the same as those of the steering wheel 100 according to the first embodiment, and thus the same components are denoted by the same reference numerals, and detailed description thereof is omitted.

The first surrounding portion 41a is different from the first surrounding portion 41 according to the first embodiment in that a positioning portion E1 is provided. The positioning portion E1 is a portion for performing the positioning with the second surrounding portion 12a of the lens member 10. In the present embodiment, the positioning portion E1 is formed as a recessed portion provided in an outer peripheral surface of the first surrounding portion 41a. In the present embodiment, the positioning portion E1 is formed in the entire first surrounding portion 41a in the circumferential direction. The recessed portion serving as the positioning portion E1 may be formed in a part of the first surrounding portion 41a in the circumferential direction.

The second surrounding portion 12a is different from the second surrounding portion 12 according to the first embodiment in that a protrusion portion p1 is provided in an inner peripheral surface of the protrusion 13. In the present embodiment, the protrusion portion p1 is formed in the entire second surrounding portion 12a in the circumferential direction. The protrusion portion p1 may be formed in a part of the second surrounding portion 12a in the circumferential direction.

In the assembled state, the protrusion portion p1 of the second surrounding portion 12a is fitted into the positioning portion E1 of the first surrounding portion 41a. Accordingly, positioning of the first surrounding portion 41a and the second surrounding portion 12a is facilitated.

The illumination device 200 according to the second embodiment described above achieves the same effects as those of the illumination device 200 according to the first embodiment. In addition, since the first surrounding portion 41a includes the positioning portion E1 for performing the positioning with the second surrounding portion 12a, the positioning of the first surrounding portion 41a and the second surrounding portion 12a can be easily achieved.

### C. Third Embodiment

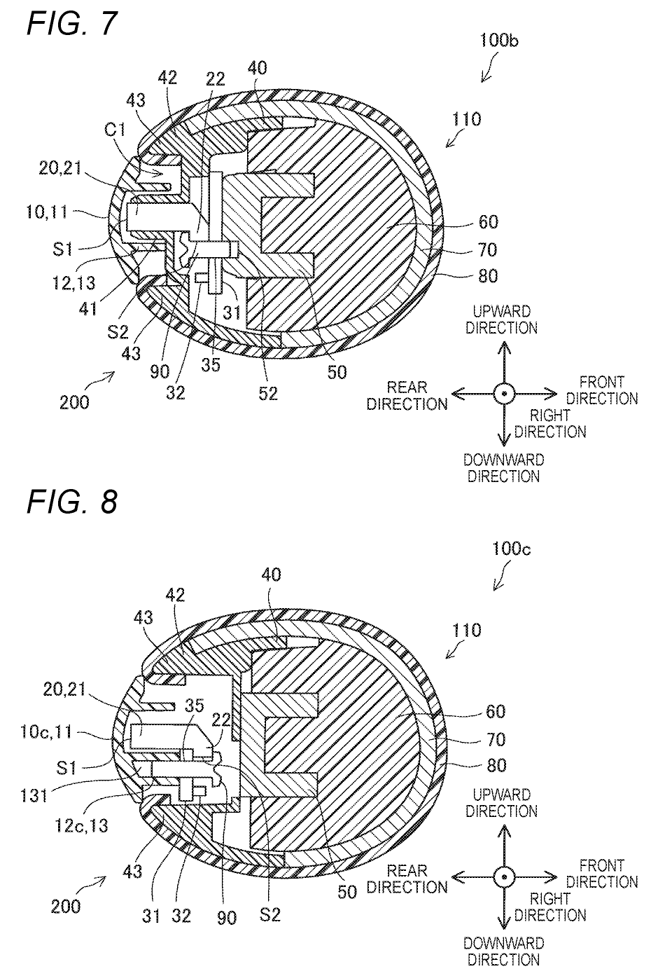

FIG. 7 is a sectional view showing a cross section of a steering wheel 100b according to a third embodiment. The steering wheel 100b according to the third embodiment is different from the steering wheel 100 according to the first embodiment in that the substrate 31 is held by being sandwiched between the light guiding member 20 and the core member 50. Other components of the steering wheel 100b according to the third embodiment are the same as those of the steering wheel 100 according to the first embodiment, and thus the same components are denoted by the same reference numerals, and detailed description thereof is omitted.

Screw holes 52 are formed in the core member 50. The screws 90 are screwed into the screw holes 52. As shown in FIG. 7, the second light guiding portion 22 of the light guiding member 20 is in contact with the surface of the substrate 31 on the rear direction side. An end surface of the core member 50 on the rear direction side is in contact with the surface of the substrate 31 on the front direction side. Then, the screws 90 are screwed into the screw holes 52 of the core member 50 through the through holes 35 of the substrate 31 while pressing the second light guiding portion 22 in the front direction, so that the substrate 31 is held by being sandwiched between the light guiding member 20 and the core member 50.

The illumination device 200 according to the third embodiment described above achieves the same effects as those of the illumination device 200 according to the first embodiment. In addition, since the substrate 31 is held by being sandwiched between the light guiding member 20 and the core member 50 resistant to an impact, it is possible to restrain occurrence of a positional misalignment of the substrate 31 even when an impact is applied from the outside. Further, heat in the substrate 31 can be easily dissipated to the core member 50.

### D. Fourth Embodiment

FIG. 8 is a sectional view showing a cross section of a steering wheel 100c according to a fourth embodiment. The steering wheel 100c according to the fourth embodiment is different from the steering wheel 100 according to the first embodiment in that a lens member 10c is provided instead of the lens member 10, and that the substrate 31 is held by being sandwiched between the light guiding member 20 and the lens member 10c. Other components of the steering wheel 100c according to the fourth embodiment are the same as those of the steering wheel 100 according to the first embodiment, and thus the same components are denoted by the same reference numerals, and detailed description thereof is omitted.

The lens member 10c includes a second surrounding portion 12c instead of the second surrounding portion 12. The second surrounding portion 12c is different from the second surrounding portion 12 according to the first embodiment in that screw holes 131 are formed in the protrusion 13. The screws 90 are screwed into the screw holes 131.

As shown in FIG. 8, an end portion of the second surrounding portion 12c (protrusion 13) is in contact with the surface of the substrate 31 on the rear direction side. Further, the second light guiding portion 22 of the light guiding member 20 is in contact with the surface of the substrate 31 on the front direction side. Then, the screws 90 are screwed into the screw holes 131 of the second surrounding portion 12c through the through holes 35 of the substrate 31 while pressing the second light guiding portion 22 in the rear direction, so that the substrate 31 is held by being sandwiched between the light guiding member 20 and the lens member 10c.

The illumination device 200 according to the fourth embodiment described above achieves the same effects as those of the illumination device 200 according to the first embodiment. In addition, since the substrate 31 is held by being sandwiched between the light guiding member 20 and the lens member 10c, it is possible to easily align the center of the light guiding member 20 (first light guiding portion 21) with the center of the lens member 10c and to easily maintain an aligned state thereof. An assembly in which the substrate 31, the lens member 10c, and the light guiding member 20 are integrated can be used as a separate member from other members constituting the steering wheel 100c. Therefore, for example, when the leather member is wound to form the outer skin layer 80 as the outermost layer of the steering wheel 100c, the leather member can be wound in a state in which the assembly is removed, and working efficiency can be improved. Since the lens member 10c includes the second surrounding portion 12c surrounding at least a part of the side surface of the first light guiding portion 21 over the entire periphery of the first light guiding portion 21, positioning of the first light guiding portion 21 at the time of assembly can be facilitated, and the positional misalignment of the first light guiding portion 21 at the time of use can be restrained.

According to the first embodiment and the second embodiment, the substrate 31 is held by being sandwiched between the light guiding member 20 and the base member 40. According to the third embodiment, the substrate 31 is held by being sandwiched between the light guiding member 20 and the core member 50. According to the fourth embodiment, the substrate 31 is held by being sandwiched between the light guiding member 20 and the lens member 10c. As is clear from these embodiments, when a member, which is different from the substrate 31, the lens members 10 and 10c, and the light guiding member 20, is referred to as the "separate member", the present disclosure can be applied to an illumination device having any configuration in which the substrate 31 is held by being sandwiched between the light guiding member 20 and the lens member 10c or the separate member.

### E. Other Embodiments

E1 In the embodiments, the substrate 31 is attached to the base member 40, the core member 50, or the lens member 10c due to the screwing, but the present disclosure is not limited thereto. For example, a configuration may be used in which the base member 40 or the like includes engaging claws, and the substrate 31 is attached by engaging the engaging claws with the substrate 31. In addition, for example, the substrate 31 may be attached by adhesion with an adhesive and the like, welding, and the like.

E2 In the second embodiment, the positioning portion E1 is configured as a recessed portion and is fitted to the protrusion portion p1 of the second surrounding portion 12a, but the present disclosure is not limited thereto. A recessed portion may be provided in the second surrounding portion 12a, and the positioning portion E1 may be configured as a protrusion portion to be fitted to the recessed portion. Further, the first surrounding portion 41a may include a positioning portion for performing positioning with the first light guiding portion 21 instead of the positioning portion E1 or in addition to the positioning portion E1. In such a configuration, the positioning portion for performing positioning with the first light guiding portion 21 may be configured as a recessed portion to be fitted to a convex portion provided on the side surface of the first light guiding portion 21, similarly to the positioning portion E1.

E3 In the embodiments, the illumination device 200 is provided in the grip portion 110, but the present disclosure is not limited thereto. For example, a configuration may be used in which the illumination device 200 may be provided in any portion of the steering wheels 100 and 100a to 100c, such as the boss portion 130 and the spoke portions 120. In this case, the shape and the configuration of the illumination device 200 can be appropriately changed in accordance with the size, shape, and the like of a place in which the illumination device 200 is provided. The position of the illumination device 200 is preferably a position that can be viewed directly by the driver. However, for example, in a case in which the light emitted from the illumination device 200 is reflected on a surface of any portion in the vehicle, for example, a surface of an instrument panel, and the reflected light can be viewed by the driver, the position of the illumination device 200 may be a position that cannot be viewed directly by the driver.

E4 The configurations of the steering wheels 100 and 100a to 100c of the embodiments are merely examples, and can be variously changed. For example, in the embodiments, the protrusion 13 may be omitted. Further, in the embodiments, the plurality of second LEDs 33 may be omitted. In addition, in the embodiments, the cross-sectional shape along the axis AX of the light guiding member 20 is a substantially L shape. That is, the first direction and the second direction are orthogonal to each other. However, a configuration may be used in which the first light guiding portion 21 and the second light guiding portion 22 are disposed such that these directions intersect at any angle other than 90°.

The present disclosure is not limited to the above embodiments, and can be implemented by various configurations without departing from the gist of the present disclosure. For example, the technical features in each embodiment corresponding to the technical features in the aspects described in the summary of the invention can be replaced or combined appropriately in order to solve a part or all of the above problems or in order to achieve a part or all of the above effects. Further, unless the technical features are described as being essential in the present specification, the technical features can be appropriately deleted.

### REFERENCE SIGNS LIST

10 lens member

10c lens member

11 diffusion surface forming portion

12 second surrounding portion

12a second surrounding portion

12c second surrounding portion

13 protrusion

14 engaging hole

15 engaging wall

19 light emitting region

20 light guiding member

21 first light guiding portion

22 second light guiding portion

23 deflection portion

24 deflection surface

25 diffusion portion

30 light emitting portion

31 substrate

32 first LED

33 second LED

35 through hole

40 base member

41 first surrounding portion

41a first surrounding portion

42 covering portion

43 top portion

44 engaging claw

45 engaging wall

46 screw hole

50 core member

52 screw hole

60 core portion

70 element layer

80 outer skin layer

90 screw

100 steering wheel

100a steering wheel

100b steering wheel

100c steering wheel

110 grip portion

120 spoke portion

130 boss portion

131 screw hole

200 illumination device

AX axis

C1 recess

E1 positioning portion

S1 emission surface

S2 incident surface

SH steering shaft

g1 group

p1 protrusion portion

What is claimed is:

1. An illumination device to be provided in a steering wheel, comprising:
a substrate provided with a light emitting element on a surface of the substrate;
a lens member that is light-transmissive so that visible light output from the light emitting element is emitted to an outside of the steering wheel;
a light guiding member configured to guide the visible light output from the light emitting element to the lens member; and
a separate member different from the substrate, the lens member and the light guiding member, wherein
the substrate is held by being sandwiched between the light guiding member and the lens member or the separate member.

2. The illumination device according to claim 1, wherein
the separate member includes a base member to which the substrate and the lens member are attached and which holds the substrate and the lens member, and
the substrate is held by being sandwiched between the light guiding member and the base member.

3. The illumination device according to claim 2, wherein
the light guiding member includes a first light guiding portion having an emission surface through which the visible light is emitted from the light guiding member to the lens member, the first light guiding portion extending along a first direction from the surface of the substrate toward the lens member,
the base member includes a first surrounding portion surrounding at least a part of a side surface of the first light guiding portion over an entire periphery of the first light guiding portion, and
the first surrounding portion and the substrate are in contact with the first light guiding portion.

4. The illumination device according to claim 3, wherein
the lens member includes a second surrounding portion surrounding at least a part of a side surface of the first light guiding portion over an entire periphery of the first light guiding portion, and
the first surrounding portion includes a positioning portion for positioning at least one of the first light guiding portion and the second surrounding portion.

5. The illumination device according to claim 1, wherein
the separate member includes a core member forming a framework of the steering wheel, and
the substrate is held by being sandwiched between the light guiding member and the core member.

6. The illumination device according to claim 1, wherein
the substrate is held by being sandwiched between the light guiding member and the lens member.

7. The illumination device according to claim 6, wherein
the light guiding member includes a first light guiding portion having an emission surface through which the visible light is emitted from the light guiding member to the lens member, the first light guiding portion extending along a first direction from the surface of the substrate toward the lens member,
the lens member includes a second surrounding portion surrounding at least a part of a side surface of the first light guiding portion over an entire periphery of the first light guiding portion, and
the substrate is held by being sandwiched between the light guiding member and an end portion of the second surrounding portion.
